(19) United States
(12) Patent Application Publication
(10) Pub. No.: US 2012/0225335 A1
(43) Pub. Date: Sep. 6, 2012

(54) BATTERY MODULE

(76) Inventors: Keisuke Naito, Osaka (JP); Takuya Nakashima, Osaka (JP)

(21) Appl. No.: 13/509,490

(22) PCT Filed: Jul. 25, 2011
(86) PCT No.: PCT/JP2011/004177

§ 371 Date: May 11, 2012

(30) Foreign Application Priority Data
Jul. 29, 2010 (JP) 2010-169997

(51) Int. Cl. H01M 2/12

(52) U.S. Cl. 429/82

(57) ABSTRACT

A battery module which is able to discharge high-temperature gas emitted from an abnormal battery cell to the outside of a case, without adversely affecting normal battery cells, while suppressing as much as possible an increase in the volume of the battery module due to an exhaust chamber, is provided. The battery module of the present invention includes: a case having an opening, and an exhaust port for discharging gas generated inside the case; a plurality of battery cells each having a terminal plate in which an open part for discharging gas generated inside the cell is provided, the battery cells being arranged inside the case with the terminal plates facing the opening of the case; and a lid attached to the case so as to cover the opening of the case, the lid including a flat plate, and a plurality of convex parts which protrude from a plane including the flat plate toward the inside of the case, and are connected to the terminal plates of the battery cells. A gas flow path leading from the open part of each battery cell to the exhaust port of the case is formed by gaps formed between the convex parts of the lid.

### TECHNICAL FIELD

The present invention relates to battery modules each comprising a plurality of battery cells housed in a case. More particularly, the present invention relates to a battery module having a discharge mechanism for safely discharging exhaust gas emitted from a battery cells to the outside of the case.

### BACKGROUND ART

Battery modules each comprising a plurality of battery cells housed in a case are widely used as power sources for various devices, vehicles, and the like. In a battery module, versatile battery cells are connected in parallel or in series to obtain desired voltage and capacitance. A technique is beginning to be employed, in which various battery modules are combined so as to be applicable to a wide variety of uses. When the performance of battery cells housed in a battery module is improved, reduction in size and weight of the battery module is achieved. Thereby, the workability in assembling a battery pack is improved, and the degree of freedom in mounting the battery pack into a limited space in a vehicle or the like is increased.

With improvement of the performance of battery cells housed in a battery module, it is increasingly important to ensure the safety of the battery module as an aggregate of a plurality of battery cells, as well as ensure the safety of each battery cell. In particular, in a case where heat generation in a battery cell due to an internal short circuit or the like causes gas and then a safety valve is activated to release the high-temperature gas from the battery cell, if neighboring battery cells are exposed to the high-temperature gas, even normal battery cells are affected by the gas, which might cause chained deterioration of the battery cells.

In order to solve the above problem, Patent Literature 1 discloses a power source device in which a partition wall is provided in a case that houses a plurality of battery cells to separate a battery chamber for housing the battery cells from an exhaust chamber for discharging high-temperature gas emitted from any of the battery cells, and an opening of a safety valve of each battery cell is communicated with the exhaust chamber. The exhaust mechanism thus configured causes the high-temperature gas emitted from the safety value of the battery cell to flow, not into the battery chamber, but into the exhaust chamber, and to be discharged from an exhaust port of the case to the outside. Thus, the neighboring battery cells are prevented from being exposed to the high-temperature gas emitted from the abnormal battery cell, thereby reducing the adverse effect on the normal battery cells.

### Citation List

### Patent Literature

[PTL 1] Japanese Laid-Open Patent Publication No. 2007-27011

### SUMMARY OF THE INVENTION

### Problems to be Solved by the Invention

In the exhaust mechanism disclosed in Patent Literature 1, the exhaust chamber is hermetically sealed to prevent the gas that has flowed through the opening of the battery cell into the exhaust chamber from flowing into the battery chamber again. Accordingly, this exhaust mechanism is excellent in preventing chained deterioration of normal battery cells due to the generated gas.

However, the gas that has flowed into the exhaust chamber might reach a high temperature of 1000° C. or more, and might react with oxygen to combust. In this case, since the exhaust chamber is exposed to such high temperature, the fear still remains that the battery cells housed in the battery chamber might be adversely affected.

Further, since the exhaust chamber is located on and in parallel to electrodes of a plurality of battery cells, the volume of the battery module is increased, and a problem remains unsolved that the power per unit volume of the battery module is reduced.

Accordingly, an object of the present invention is to proved a safe and secure battery module which is able to discharge high-temperature gas emitted from an abnormal battery cell to the outside of a case, without adversely affecting other normal battery cells, while suppressing as much as possible an increase in the volume of the battery module.

### Solution to the Problems

A battery module according to the present invention includes: a case having an opening, and an exhaust port for discharging gas generated inside the case; a plurality of battery cells each having a terminal plate in which an open part for discharging gas generated inside the cell is provided, the battery cells being arranged inside the case with the terminal plates facing the opening of the case; and a lid attached to the case so as to cover the opening of the case, the lid including a flat plate, and a plurality of convex parts which protrude from a plane including the flat plate toward the inside of the case, and are connected to the terminal plates of the battery cells.

### Advantageous Effects of the Invention

According to the present invention, since gas flow paths are formed between a plurality of convex parts formed in a power collector, it is possible to discharge high-temperature gas emitted from an abnormal battery cell to the outside of the case, without adversely affecting other normal battery cells, while suppressing as much as possible an increase in the volume of the battery module. Accordingly, it is possible to realize a safe and secure battery module having a large capacitance per unit volume.

### BRIEF DESCRIPTION OF THE DRAWINGS

FIG. 1 is a cross-sectional view schematically illustrating a structure of a battery cell used in a battery module according to a first embodiment.

FIG. 2 is a perspective view schematically illustrating an external view of the battery module according to the first embodiment.

FIG. 3 is a cross-sectional view taken along a line shown in FIG. 2.

FIG. 4 is a diagram illustrating a flow of gas emitted from an open part of a battery cell.

FIG. 5 is a perspective view schematically illustrating an external view of a battery module according to a second embodiment.

### DESCRIPTION OF EMBODIMENTS

### Embodiment 1

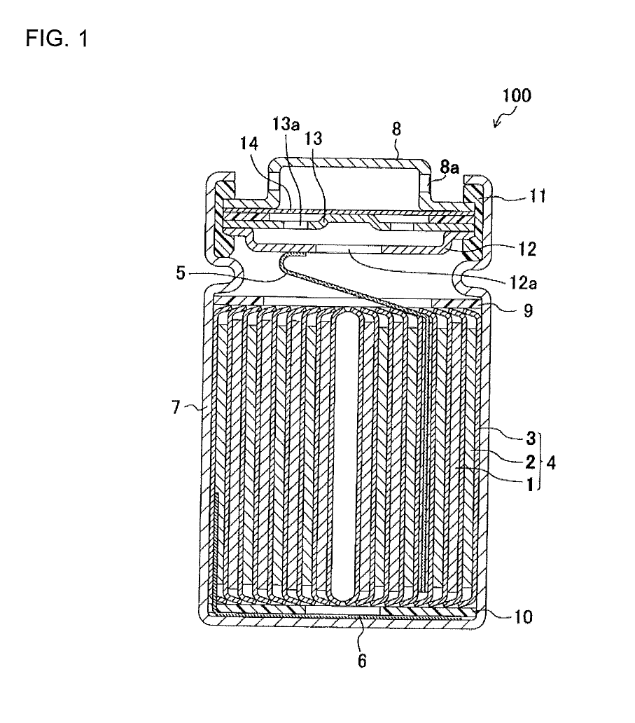

FIG. 1 is a cross-sectional view schematically illustrating a structure of a battery cell 100 used in a battery module according to a first embodiment. The battery cell used in the battery module of the present invention may be a battery cell that can be solely used as a power source for portable electronic equipment such as a lap-top personal computer (hereinafter, a battery cell used in a battery module is referred to as “unit cell”). In this case, since a high-performance versatile battery cell can be used as a unit cell of the battery module, performance improvement and cost reduction of the battery module can be easily achieved.

For example, a cylindrical lithium-ion secondary cell as shown in FIG. 1 may be used as the unit cell 100 in the battery module of the present invention. The lithium-ion secondary cell includes a safety mechanism for releasing, to the outside of the cell, gas that is generated when the pressure inside the cell is increased due to an internal short-circuit or the like. Hereinafter, the specific structure of the unit cell 100 will be described with reference to FIG. 1.

As shown in FIG. 1, an electrode assembly 4 in which a positive electrode 1 and a negative electrode 2 are wound with a separator 3 interposed therebetween is housed in a cell case 7 together with a non-aqueous electrolyte. Insulating plates 9 and 10 are provided at the top and bottom of the electrode assembly 4, respectively. The positive electrode 1 is connected to a filter 12 via a positive electrode lead 5. The negative electrode 2 is connected, via a negative electrode lead 6, to the bottom of the cell case 7 which also serves as a negative electrode terminal.

The filter 12 is connected to an inner cap 13, and a protrusion of the inner cap 13 is connected to a vent plate 14 made of a metal. The vent plate 14 is connected to a terminal plate 8 which also serves as a positive electrode terminal. An opening of the cell case 7 is sealed with the terminal plate 8, the vent plate 14, the inner cap 13, and the filter 12 which are integrated with each other, via a gasket 11.

When an internal short circuit or the like occurs in the unit cell 100 and the pressure inside the unit cell 100 is increased, the vent plate 14 swells toward the terminal plate 8. When the vent plate 14 swells, the inner cap 13 and the vent plate 14 are disconnected from each other, and thus the current path is cut off. If the pressure inside the unit cell 100 is further increased, the vent plate 14 is broken. Then, gas generated inside the unit cell 100 is discharged to the outside through a through-hole 12a of the filter 12, a through-hole 13a of the inner cap 13, a break in the vent plate 14, and an open part 8a of the terminal plate 8.

The structure of the safety mechanism for discharging the gas generated in the unit cell 100 to the outside is not limited to that shown in FIG. 1. The safety mechanism may have a different structure.

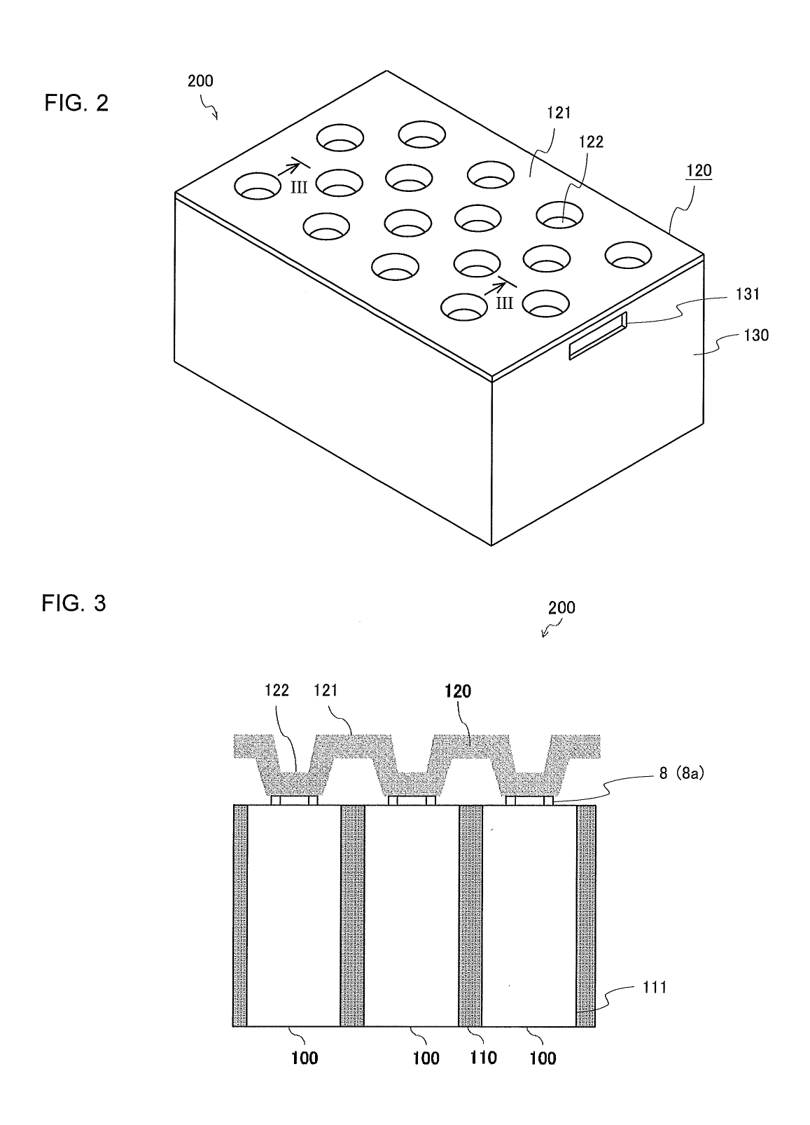

FIG. 2 is a perspective view schematically illustrating an external view of a battery module according to the first embodiment. FIG. 3 is a cross-sectional view taken along a line in FIG. 2.

As shown in FIGS. 2 and 3, a battery module 200 includes a case 130, a plurality of unit cells 100 housed in the case 130, a cell holding member 110 that holds the unit cells 100, and a lid 120 attached so as to cover the opening of the case 130.

The case 130 has a rectangular parallelepiped box shape, one side of which is open. An exhaust port 131 for discharging gas generated inside the battery module 200 is provided on a side of the case 130 at a position near the opening of the case 130. A plurality of unit cells 100 are housed in the case 130, with the terminal plates 8 thereof facing the opening of the case 130.

The cell holding member 110 has a plurality of cell housing parts 111 in which the plurality of unit cells 100 are housed. Each of the cell housing parts 111 is a hole corresponding to the outer shape of the cell case 7. The inner diameter of the cell housing part 111 is approximately equal to the outer diameter of the cell case 7, and the depth of the cell housing part 111 is approximately equal to the height of the outer circumferential wall of the cell case 7. Accordingly, as shown in FIG. 3, when a unit cell 100 is inserted in a cell housing part 111, a portion of the terminal plate 8 protrudes from the cell housing part 111, and the outer surface of the cell case 7 is closely fitted to the inner circumferential surface of the cell housing part 111. Since the unit cell 100 is thus held by the cell holding member 110, when gas is released from the open part of the unit cell 100, the released gas is prevented from running into a space beneath the upper end of the cell holding member 110, i.e., the upper end of the side surface of the cell case 7 of the unit cell 100. Therefore, neighboring unit cells 100 are prevented from being burnt due to the gas emitted from the unit cell 100. Further, since the outer surface of the cell case 7 and the inner circumferential surface of the cell housing part 111 are closely fitted to each other, the cell holding member 110 can be caused to function as a thermal buffer by forming the cell holding member 110 using a material having thermal conductivity.

A lid 120 is a member attached so as to cover the opening of the case 130, and simultaneously, the lid 120 has a function as a power collector. The lid 120 is made of a conductive material, and includes a flat plate 121, and a plurality of spot-shaped convex parts 122 protruding from a plane including the flat plate 121 toward the inside of the case 130. The plurality of spot-shaped convex parts 122 are dispersedly provided in the lid. An end of each convex part 122 has a flat surface, and the terminal plate 8 of each unit cell 100 is connected to the flat surface. When the convex parts 122 dispersedly provided in the lid 120 are connected to the terminal plates 8, a continuous space is formed between the convex parts 122, and thereby flow paths leading from the respective terminal plates 8 to the exhaust port 131 on the side surface of the case 130 are formed between the lid 120 and the cell holding member 110 in which the unit cells 100 are housed. In the present embodiment, the number of the unit cells 100 are equal to the number of the convex parts 122, and the unit cells 100 and the convex parts 122 correspond to each other in a one-to-one fashion.

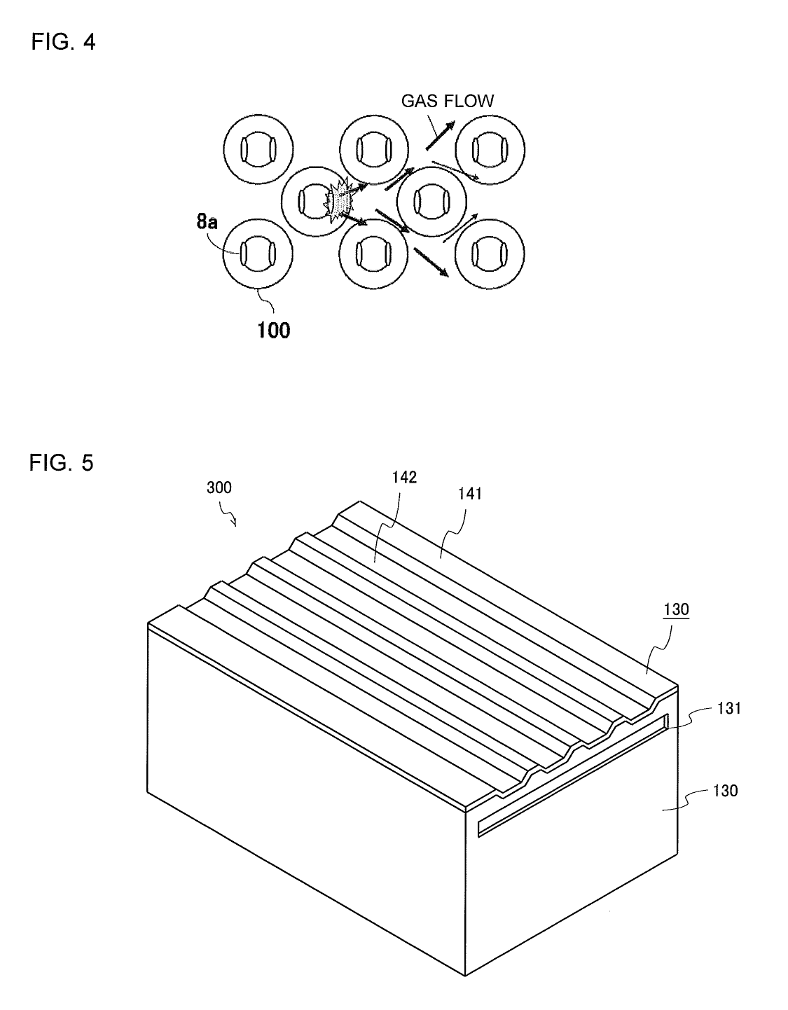

FIG. 4 is a diagram showing a flow path of gas emitted from the opening of a certain cell.

As described above, it is difficult for gas to pass through the connection between the positive terminal of the unit cell 100 and the convex part 122 of the lid 120, while it is easy for gas to pass through the space between the convex parts 122. Therefore, as shown in FIG. 4, gas emitted from the open part 8a of a certain unit cell 100 flows through the space formed between the convex parts 122 and is discharged from the exhaust port 131 of the case 130 to the outside.

In the above configuration, the structure of the lid 120 for hermetically sealing the plurality of unit cells 100 in the case 130 provides the gas flow paths above the unit cells 100. Therefore, it is possible to realize a safe and secure battery module which is able to discharge high-temperature gas emitted from an abnormal cell to the outside of the case 130, while suppressing as much as possible an increase in the volume of the battery module 200. Further, since the lid 120 also serves as a power collector, the lid 120 is suitable for a battery module which realizes desired voltage and capacitance by using a plurality of unit cells 100.

### Embodiment 2

FIG. 5 is a perspective view schematically illustrating an external view of a battery module according to a second embodiment. The battery module 300 of the second embodiment is different from the battery module 200 of the first embodiment in the shape of a lid 140. Hereinafter, the difference between the second embodiment and the first embodiment will be mainly described.

In the lid 120 of the first embodiment, the plurality of spot-shaped convex parts 122 to be connected to the unit cells 100 are dispersedly provided. On the other hand, in the lid 140 of the present embodiment, linear convex parts 142 protruding from a plane including a flat plate 141 are formed in stripes, that is, the lid 140 is corrugated. As in the first embodiment, the positive terminals of the unit cells 100 are connected to the end surfaces of the convex parts 142. In the present embodiment, however, a plurality of unit cells 100 are connected to one convex part 142. An exhaust port 131 is provided across almost the overall width of the case 130. Also in the battery module 300 of the present embodiment, a space formed between neighboring convex parts 142 provides a flow path leading from the positive terminal of each unit cell 100 to the exhaust port 131 of the case 130. Accordingly, also in the present embodiment, it is possible to realize a safe and secure battery module 300 which can discharge high-temperature gas emitted from an abnormal cell to the outside of the case 130, while suppressing as much as possible an increase in the volume of the battery module 300. Further, in the present embodiment, a linear space formed between neighboring convex parts 142 provides a gas flow path leading to the exhaust port 131. Since this gas flow path is shifted from the position where the cells are arrayed, gas emitted from an abnormal cell is prevented from adversely affecting other normal cells.

(Modifications)

In the above-described embodiments, the lid also serves as a power collector, and therefore, is made of a conductive material. However, an insulating member for insulating the outer surface of the lid 120 may be further provided. For example, the outer surface of the lid 120 which is made of a conductive material such as a copper plate may be coated with an insulating material, or covered with a plastic insulating film. Alternatively, the lid may be made of a metal-plastic cladding material.

In the above-described embodiments, the number, size, and location of the exhaust port provided in the case may be arbitrarily determined as long as gas emitted from an abnormal cell can be quickly discharged to the outside of the case.

Furthermore, in the above-described embodiments, a space formed between neighboring convex parts may be used as a flow path for cooling the battery module. In this case, the case or the lid is provided with an inlet through which a cooling medium is poured, and an outlet through which the cooling medium is discharged, and a flow path leading from the inlet to the outlet is formed via the space formed between the convex parts. The inlet and the outlet may double gas exhaust ports for the above-described abnormal situation.

Furthermore, while in the above embodiments spot or linear convex parts have been described, the shape of the convex parts is not particularly limited as long as a flow path is formed between neighboring convex parts.

### INDUSTRIAL APPLICABILITY

The present invention is useful as a power source for driving automobiles, electric motorcycles, electric play equipments, and the like.

### DESCRIPTION OF THE REFERENCE CHARACTERS

1 positive electrode

2 negative electrode

3 separator

4 electrode assembly

5 positive electrode lead

6 negative electrode lead

7 cell case

8 terminal plate (positive electrode terminal)

8a open part

9, 10 insulating plate

11 gasket

12 filter

12a through-hole

13 inner cap

13a through-hole

14 vent plate

100 unit cell

110 cell holding member

120 lid

121 flat plate

122 convex parts

200 battery module

130 case

131 exhaust port

140 lid

141 flat plate

142 convex parts

300 battery module

1. A battery module comprising:
a case having an opening, and an exhaust port for discharging gas generated inside the case;
a plurality of battery cells each having a terminal plate in which an open part for discharging gas generated inside the cell is provided, the battery cells being arranged inside the case with the terminal plates facing the opening of the case; and
a lid attached to the case so as to cover the opening of the case, the lid including a flat plate, and a plurality of convex parts which protrude from a plane including the flat plate toward the inside of the case, and are connected to the terminal plates of the battery cells.

2. The battery module according to claim 1, wherein
the convex parts of the lid are linear in shape, and the linear convex parts extend in stripes,
the terminal plates of a plurality of the battery cells are connected to each of the linear convex parts, and
an exhaust path leading to the exhaust port is formed by the flat plate and the convex parts.

3. The battery module according to claim 1, wherein
the convex parts of the lid are spot-shaped, and the spot convex parts are dispersed in the lid at positions corresponding to the battery cells,
the terminal plate of one battery cell is connected to each of the convex parts, and
an exhaust path leading to the exhaust port is formed by the flat plate and the convex parts.

4. The battery module according to claim 2 further including a cell holding part which is provided in the case, and fills gaps between the plurality of battery cells.

5. The battery module according to claim 2, wherein the lid is electrically connected to the terminal plates of the plurality of battery cells, and collects electrical power from the plurality of battery cells connected in parallel.

6. The battery module according to claim 5, wherein
the lid is made of a conductive material, and
an external surface of the lid is covered with an insulating member.

7. The battery module according to claim 3 further including a cell holding part which is provided in the case, and fills gaps between the plurality of battery cells.

8. The battery module according to claim 3, wherein the lid is electrically connected to the terminal plates of the plurality of battery cells, and collects electrical power form the plurality of battery cells connected in parallel.

9. The battery module according to claim 8, wherein
the lid is made of a conductive material, and
an external surface of the lid is covered with an insulating member.
